(19) United States
(12) Patent Application Publication
(10) Pub. No.: US 2016/0212674 A1
(43) Pub. Date: Jul. 21, 2016

(54) COMMUNICATION CONTROL DEVICE, COMMUNICATION CONTROL METHOD AND PROGRAM

(71) Applicant: KABUSHIKI KAISHA TOSHIBA, Minato-ku, Tokyo (JP)

(72) Inventors: Kohta NAKAMURA, Fuchu (JP); Keiji YAMAMOTO, Ome (JP); Taichi TASHIRO, Fuchu (JP); Kenichi OHNO, Zama (JP)

(73) Assignee: KABUSHIKI KAISHA TOSHIBA, Minato-ku, Tokyo (JP)

(21) Appl. No.: 14/913,235

(22) PCT Filed: Mar. 13, 2014
(86) PCT No.: PCT/JP2014/056803

§ 371 Date: Feb. 19, 2016

(30) Foreign Application Priority Data
Aug. 20, 2013 (JP) 2013-170732

(51) Int. Cl. H04W 36/30; H04L 12/853; H04L 12/851; H04L 12/859; H04W 36/00; H04M 3/22

(52) U.S. Cl. CPC H04W 36/30; H04W 36/0094; H04M 3/2236; H04L 47/2425; H04L 47/2475; H04L 47/2416

(57) ABSTRACT

A communication control device includes a controller and a change unit. The controller performs handover to switch a base station for a wireless packet communication with an information processing terminal when a received power of a received signal falls below a preset handover threshold. The received signal is received by the information processing terminal from the base station via the wireless packet communication. The change unit changes the threshold on the basis of a type of an application and at least either an error rate or a delay time of the wireless packet communication between the information processing terminal and the base station. The application is involved in the wireless packet communication between the information processing terminal and the base station.

### FIELD

Embodiments of the present invention relate to a communication control device, a communication control method and a program.

### BACKGROUND

In response to demands for further increasing mobile communication speed to deal with increases in mobile traffic year after year, each telecommunications carrier has launched high-speed wireless communication called an LTE (Long Term Evolution) service. Indoor mobile traffic has also been increasing year by year. Along with a further growth in indoor mobile traffic, improvement in wireless communication quality of the indoor mobile traffic is desired.

### CITATION LIST

### Patent Literature

Patent Literature 1: Japanese Laid-open Patent Application No. 2005-101930

### SUMMARY OF THE INVENTION

### Problem to be Solved by the Invention

To improve the indoor mobile traffic, a large number of base stations each having a femtocell with a signal radius of several tens of meters need to be disposed at a close range. However, a large number of base stations provided at a close range mean an increase in the frequency of handover of an information processing terminal in wireless communication with the base stations. This causes a problem in an information processing terminal requiring stable communication to transmit/receive data used in a voice call through a network that the increase in handover frequency results in lowering voice quality.

### Means for Solving Problem

A communication control device according to an embodiment comprises a controller and a change unit. The controller performs handover to switch a base station for a wireless packet communication with an information processing terminal when a received power of a received signal by the information processing terminal from the base station via the wireless packet communication falls below a preset handover threshold. The change unit changes the threshold on the basis of at least either an error rate or a delay time of the wireless packet communication between the information processing terminal and the base station and a type of an application involved in the wireless packet communication between the information processing terminal and the base station.

### BRIEF DESCRIPTION OF DRAWINGS

FIG. 1 is a block diagram illustrating a configuration of a communication control system according to a first embodiment.

FIG. 2 is a diagram illustrating a schematic configuration of respective elements of the communication control system according to the first embodiment.

FIG. 3 is a sequence diagram illustrating a flow of a handover threshold changing process in the communication control system according to the first embodiment.

FIG. 4 is a diagram illustrating a basic handover threshold changing process in the communication control system according to the first embodiment.

FIG. 5 is a diagram illustrating the handover threshold changing process on the basis of priority preset to a terminal in the communication control system according to the first embodiment.

FIG. 6 is a diagram illustrating a process of restraining retransmission of a received signal via wireless packet communication in the communication control system according to the first embodiment.

FIG. 7 is a block diagram illustrating a configuration of a communication control system according to a second embodiment.

FIG. 8 is a diagram illustrating a schematic configuration of respective elements of the communication control system according to the second embodiment.

FIG. 9 is a sequence diagram illustrating a flow of the handover threshold changing process in the communication control system according to the second embodiment.

### DETAILED DESCRIPTION

There will be now described a configuration of a communication control system to which a communication control device, a communication control method and a program according to the present embodiment are applied, with reference to the accompanying drawings.

### First Embodiment

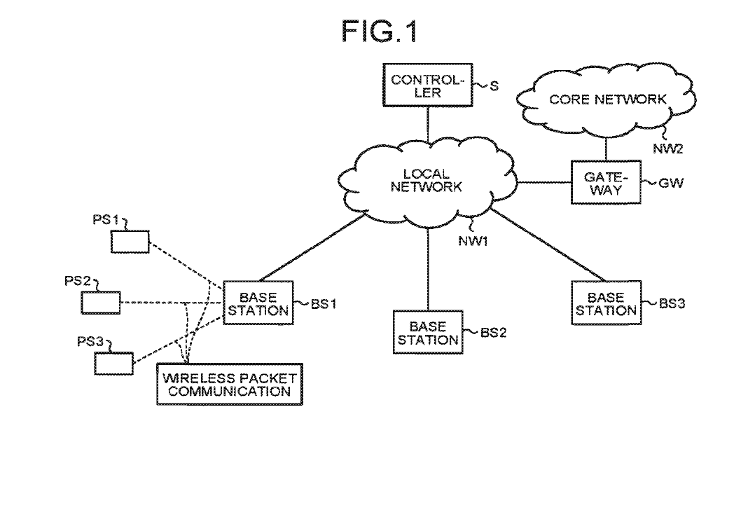

FIG. 1 is a block diagram illustrating a configuration of a communication control system according to a first embodiment. As illustrated in FIG. 1, the communication control system of the present embodiment includes a plurality of terminals PS1, PS2, and PS3 (hereinafter simply referred to as a terminal or terminals PS when the terminals PS1, PS2 and PS3 do not need to be distinguished from one another) including a mobile phone, a smart phone, a tablet terminal, or a notebook PC (Personal Computer) and capable of wireless packet communication, a plurality of base stations BS1, BS2, and BS3 (hereinafter simply referred to as a base station or stations BS when the base stations BS1, BS2 and BS3 do not need to be distinguished from one another) capable of wireless packet communication with the plurality of terminals PS, a controller S that performs handover to switch the base station BS for the wireless packet communication with the terminal PS, a local network NW1 used in a facility in which the controller S and the plurality of base stations BS are installed, a core network NW2 that is a high-capacity communication line network connecting the local network NW1 and another local network not illustrated, and a gateway GW connecting the local network NW1 and the core network NW2. While the present embodiment describes an example where the communication control system includes the three base stations BS connected to the local network NW1, the system needs to include at least two base stations BS and may include four or more base stations BS, for example.

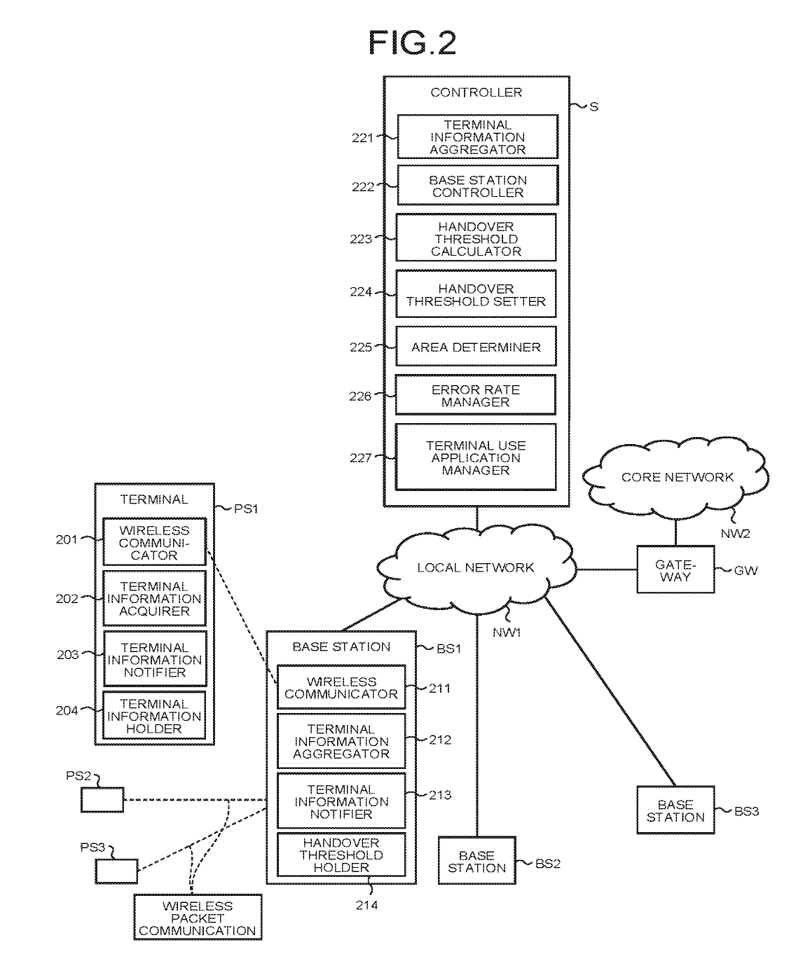

FIG. 2 is a diagram illustrating a schematic configuration of respective elements of the communication control system according to the first embodiment. As illustrated in FIG. 2, the terminal PS includes a wireless communicator 201 capable of wireless packet communication with the base station BS, a terminal information acquirer 202 that acquires terminal information including an error rate and a delay time of the wireless packet communication between the terminal PS and the base station BS, a terminal information notifier 203 that notifies the base station BS of the terminal information acquired by the terminal information acquirer 202, and a terminal information holder 204 that holds (stores) the terminal information.

In the present embodiment, the terminal information includes received power of a received signal from the base station BS via the wireless packet communication, a physical cell ID for identifying a cell in the base station BS in the wireless packet communication, an application type indicating the type of an application (hereinafter will be referred to as a wireless communication application) involved in the wireless packet communication between the terminal PS and the base station BS, a codec type indicating the type of a codec used in encoding and decoding a signal transmitted/received between the terminal PS and the base station BS via the wireless packet communication, throughput of the wireless packet communication, the error rate and delay time of the wireless packet communication involved in the wireless communication application executed by the terminal PS, and priority preset to the terminal PS. In the present embodiment, the priority of the terminal PS is set on the basis of a bit rate guaranteed for the wireless packet communication of the terminal PS. Specifically, higher priority is set to the terminal PS with a higher bit rate guaranteed for the wireless packet communication.

Moreover, as illustrated in FIG. 2, the base station BS includes a wireless communicator 211 for the wireless packet communication with the terminal PS located in its own cell, a terminal information aggregator 212 that receives the terminal information from the terminal PS in the wireless packet communication and stores the received terminal information, a terminal information notifier 213 that notifies the controller S of the terminal information received from the terminal information aggregator 212 through the local network NW1, and a handover threshold holder 214 that holds (stores) for each terminal PS a preset threshold (hereinafter referred to as a handover threshold) to be compared with the received power included in the received terminal information when determining whether or not to control the terminal PS to perform handover to switch the base station BS in the wireless packet communication.

In the present embodiment, the wireless communicator 211 receives the terminal information from the terminal PS and compares the received power included in the terminal information with a handover threshold of the terminal PS as a source of the terminal information from among the preset handover thresholds stored in the handover threshold holder 214 to control the terminal PS to execute handover. In other words, upon receiving the terminal information from the terminal PS, the wireless communicator 211 controls the terminal PS to execute handover when the received power included in the terminal information falls below the handover threshold of the terminal PS as a source of the terminal information, among the handover thresholds stored in the handover threshold holder 214.

Specifically, when the received power included in the received terminal information falls below the handover threshold of the terminal PS as a source of the terminal information, the wireless communicator 211 transmits a handover instruction to the terminal PS to execute handover and executes handover of the terminal PS by transmitting, to the base station BS as a handover destination, the terminal information and an undelivered packet (having not been transmitted to the source terminal PS or having been transmitted from the source terminal PS but not reached a destination). While the wireless communicator 211 directly transmits the undelivered packet to the base station BS as the handover destination in the present embodiment, the undelivered packet may also be transmitted to the base station BS as the handover destination through the controller S.

Moreover, as illustrated in FIG. 2, the controller S (an example of the communication control device) includes a terminal information aggregator 221 that receives terminal information from the connected base stations BS through the local network NW1 and stores the received terminal information, a base station controller 222 that controls the base stations BS, a handover threshold calculator 223 that calculates the handover threshold for each terminal PS in the wireless packet communication with the base stations BS, a handover threshold setter 224 (an example of a controller) that sets (notifies) the calculated handover threshold of each terminal PS to the base stations BS and executes handover when a received power of a received signal by the terminal PS from the base station BS through the wireless packet communication falls below the handover threshold, an area determiner 225 that determines, on the basis of the throughput included in the terminal information, an area (a cell of the base station BS) in which a preset throughput cannot be guaranteed, an error rate manager 226 that stores an error rate included in the terminal information, and a terminal-use application manager 227 that stores the received terminal information (such as an application type).

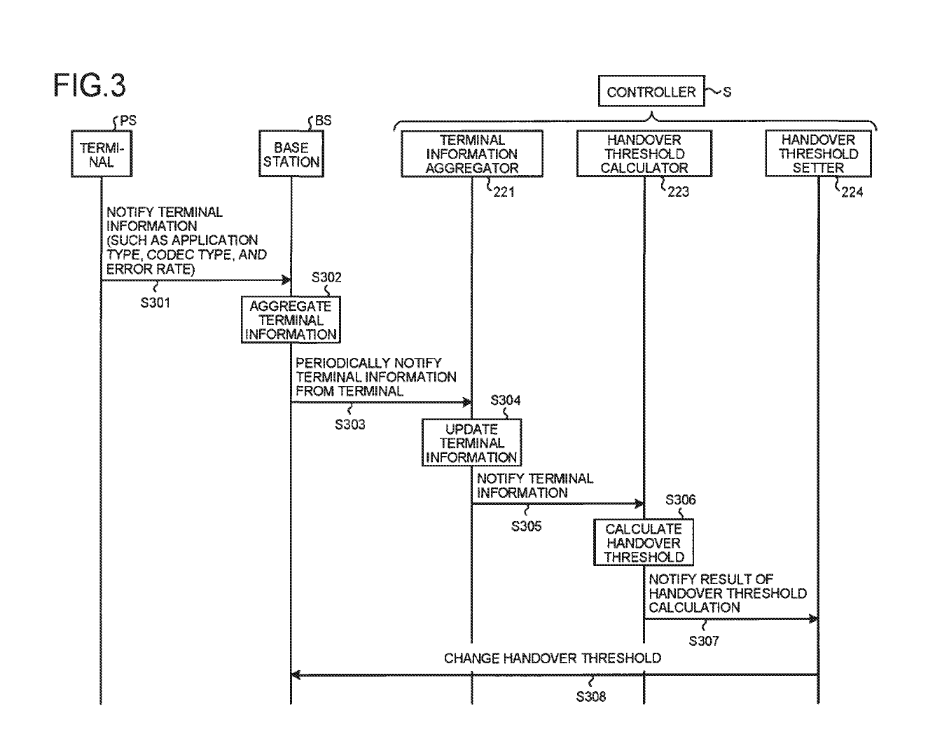

Next, referring to FIG. 3, a handover threshold changing process in the communication control system according to the present embodiment will be described. FIG. 3 is a sequence diagram illustrating a flow of the handover threshold changing process in the communication control system according to the first embodiment.

In the present embodiment, upon start of the wireless packet communication between the terminal PS and the base station BS, the handover threshold setter 224 of the controller S specifies a wireless communication application on the basis of the application type included in the terminal information that is notified first from the base station BS after the start of the wireless packet communication. The handover threshold setter 224 then sets a certain handover threshold corresponding to the specified wireless communication application to the base station BS.

Upon the start of the wireless packet communication between the terminal PS and the base station BS, the terminal information acquirer 202 of the terminal PS periodically acquires the terminal information and updates the terminal information of each terminal PS stored in the terminal information holder 204 to the acquired terminal information. Moreover, the terminal information notifier 203 notifies the terminal information to the concerning base station BS (step S301).

The terminal information aggregator 212 of the base station BS receives the terminal information from the terminal PS through the wireless packet communication and stores the received terminal information (step S302). Then, the terminal information notifier 213 periodically notifies the controller S of the received terminal information (step S303).

The terminal information aggregator 221 of the controller S receives the terminal information from the base station BS and updates the terminal information stored for each terminal PS in the terminal-use application manager 227 to the received terminal information (step S304). Moreover, the terminal information aggregator 221 notifies the handover threshold calculator 223 of the received terminal information (step S305).

The handover threshold calculator 223 calculates a handover threshold on the basis of at least either the error rate or delay time of the wireless packet communication and the application type included in the terminal information from the terminal information aggregator 221 (step S306) and notifies the handover threshold setter 224 of a result of the calculation (step S307). Then, the handover threshold setter 224 notifies the base station BS of the handover threshold from the handover threshold calculator 223 and changes the handover threshold stored in the handover threshold holder 214 of the base station BS (step S308). Therefore, in the present embodiment, the handover threshold calculator 223 and the handover threshold setter 224 function as an example of a change unit that changes the handover threshold on the basis of at least either the error rate or delay time of the wireless packet communication included in the terminal information from the terminal information aggregator 221 as well as the application type of the wireless communication application involved in the wireless packet communication between the terminal PS and the base station BS.

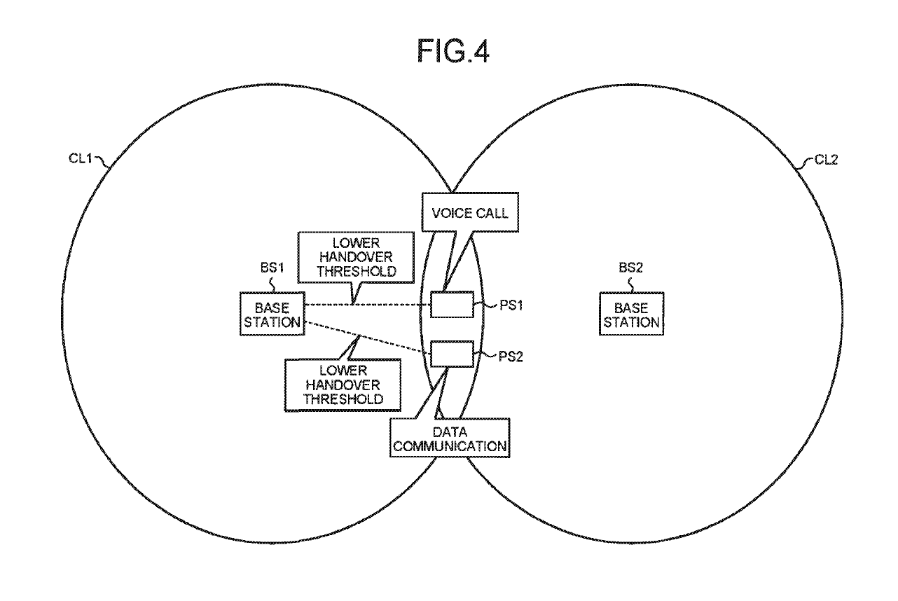

Next, referring to FIG. 4, a basic handover threshold changing process in the communication control system according to the present embodiment will be described. FIG. 4 is a diagram illustrating the basic handover threshold changing process in the communication control system according to the first embodiment. The following are an example of the handover threshold changing process to each of the terminal PS1 and the terminal PS2 in the wireless packet communication with the base station BS1 when the terminals PS1 and PS2 move to the vicinity of a boundary between a cell CL1 capable of the wireless packet communication with the base station BS1 and a cell CL2 capable of the wireless packet communication with the base station BS2, and can now conduct the wireless packet communication with both of the base station BS1 and the base station BS2.

First, the process of changing the preset handover threshold of the terminal PS1 will be described. When receiving the terminal information of the terminal PS1 from the terminal information aggregator 221, the handover threshold calculator 223 specifies the application type of a wireless application involved in the wireless packet communication between the terminal PS1 and the base station BS1, on the basis of the application type included in the terminal information. The handover threshold calculator 223 lowers the handover threshold preset to the terminal PS1 when the specified application type indicates a wireless communication application (such as a VoIP: Voice over Internet Protocol, streaming, and a real-time game) involved in a wireless packet communication having a high requirement for real-time performance (the application type indicates a high requirement for real-time communication) and when the delay time (of the wireless packet communication involved in the specified wireless communication application) included in the terminal information is shorter than a certain allowable delay time. In the present embodiment, the handover threshold calculator 223 can change the handover threshold within a range from the handover threshold before it changes to a changeable lower limit of the handover threshold.

That is, when the terminal PS1 performs wireless packet communication by the wireless communication application involved in the wireless packet communication such as a voice call and image data streaming having a high requirement for real-time communication, it is preferable that the terminal PS1 gives priority to preventing voice and image from being interrupted by frequent handovers even with an increase in the error rate of the wireless packet communication. Accordingly, the handover threshold calculator 223 lowers the preset handover threshold of the terminal PS1 when the delay time in the wireless packet communication is short, to make it difficult for the terminal PS1 to perform handover from the base station BS1 to the base station BS2 to prevent the handover of the terminal PS1 to the base station BS2 in the wireless packet communication with a longer delay time.

On the other hand, the handover threshold calculator 223 increases the preset handover threshold of the terminal PS1 even when the specified application type indicates the wireless communication application involved in the wireless packet communication having a high requirement for real-time performance (when the application type indicates a high requirement for real-time communication), if the delay time included in the terminal information of the terminal PS1 is longer than the certain allowable delay time. In the present embodiment, the handover threshold calculator 223 can change the handover threshold within a range to a changeable upper limit of the handover threshold from the handover threshold before it changes.

That is, when the terminal PS1 performs wireless packet communication by the wireless communication application involved in the wireless packet communication such as the voice call and image data streaming having a high requirement for real-time communication, it is preferable that the terminal PS1 gives priority to preventing voice and image from being interrupted by a longer delay time of the wireless packet communication than to a low error rate of the wireless packet communication. Accordingly, the handover threshold calculator 223 increases the preset handover threshold of the terminal PS1, making it easier for the terminal PS1 to perform handover from the base station PS1 to the base station BS2 and realize the handover of the terminal PS1 to the base station BS2 in the wireless packet communication with a shorter delay time.

Next, the process of changing the preset handover threshold of the terminal PS2 will be described. When receiving the terminal information of the terminal PS2 from the terminal information aggregator 221, the handover threshold calculator 223 specifies the application type of a wireless application involved in the wireless packet communication between the terminal PS2 and the base station BS1 on the basis of the application type included in the terminal information. The handover threshold calculator 223 lowers the preset handover threshold of the terminal PS2 when the specified application type indicates a wireless communication application (such as data communication including web browsing and an e-mail downloading) involved in wireless packet communication having a low requirement for real-time performance (the application type indicates a low requirement for real-time communication) and when the error rate included in the terminal information (error rate of the wireless packet communication involved in the specified wireless communication application) is shorter than a certain allowable error rate.

That is, when the terminal PS2 performs the wireless packet communication by the wireless communication application involved in the wireless packet communication such as web browsing and e-mail downloading having a low requirement for real-time communication, it is preferable that the terminal PS2 gives priority to preventing an increase in the error rate of the wireless packet communication than to eliminating the delay time of the wireless packet communication due to frequent handovers. Accordingly, the handover threshold calculator 223 lowers the preset handover threshold of the terminal PS2 when the error rate is low, making it difficult for the terminal PS2 to perform handover from the base station PS1 to the base station BS2 to prevent the handover of terminal PS2 to the base station BS2 in the wireless packet communication with a higher error rate.

On the other hand, the handover threshold calculator 223 increases the preset handover threshold of the terminal PS2 even when the specified application type indicates the wireless communication application involved in the wireless packet communication having a low requirement for real-time performance (the application type indicates a low requirement for real-time communication), if the error rate included in the terminal information of the terminal PS2 is higher than the certain allowable error rate.

That is, when the terminal PS2 performs the wireless packet communication by the wireless communication application involved in the wireless packet communication such as web browsing and e-mail downloading having a low requirement for real-time communication, it is preferable to give priority to preventing an increase in the error rate of the wireless packet communication regardless of the delay time in the wireless packet communication. Accordingly, at a high error rate the handover threshold calculator 223 increases the preset handover threshold of the terminal PS2, making it easier for the terminal PS2 to perform handover from the base station BS1 to the base station BS2 to thus lower the error rate of the wireless packet communication.

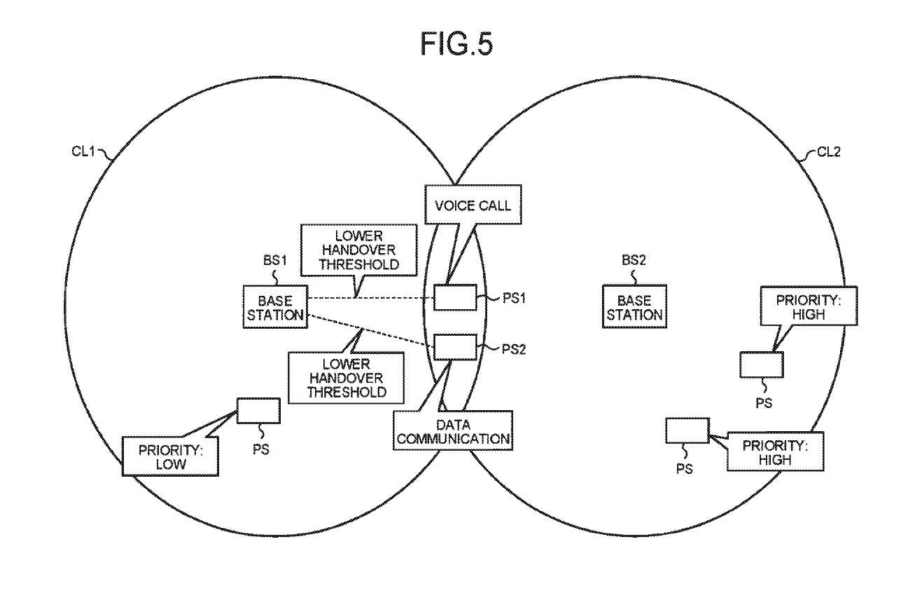

Next, referring to FIG. 5, the handover threshold changing process on the basis of priority preset to the terminal PS in the communication control system according to the present embodiment will be described. FIG. 5 is a diagram illustrating the processing for changing the handover threshold on the basis of the priority preset to the terminal in the communication control system according to the first embodiment.

Upon receiving the terminal information of the terminal PS1 from the terminal information aggregator 221, the handover threshold calculator 223 acquires from the terminal-use application manager 227 terminal information (of the terminal PS located within the cell CL1 of the base station BS1 in wireless packet communication with the terminal PS1) including a physical cell ID identical to a physical cell ID included in the received terminal information as well as terminal information (of the terminal PS located within the cell CL2 of the base station BS2 to which the terminal PS1 can perform handover) including a physical cell ID of the cell CL2 adjacent to the cell CL1 having the physical cell ID included in the received terminal information.

Next, the handover threshold calculator 223 compares the priority of the terminal PS1 included in the received terminal information with priorities included in the terminal information of the existing terminals PS in the cell CL1 of the base station BS1 and the cell CL2 of the base station BS2. The handover threshold calculator 223 then lowers the preset handover threshold of the terminal PS1 when determining that a larger number of terminals PS with a higher set priority than that of the terminal PS1 are located in the cell CL2 of the base station BS2 than the cell CL1 of the base station BS1.

This can prevent the terminal PS1 from performing handover to the base station BS2 having the cell CL2 in which the larger number of terminals PS with a higher priority are located, to decrease a bit rate of the wireless packet communication between the terminal PS1 and the base station BS2, thereby preventing degradation of the communication quality of the wireless packet communication (such as interruption of voice in a voice call from the terminal PS1 via the wireless packet communication and interruption of an image in video data received by the terminal PS1 via the wireless packet communication). This can also prevent the terminal PS1 from performing handover to the base station BS2 having the cell CL2 in which the larger number of terminals PS with a higher priority are located, which decreases a bit rate of the wireless packet communication between the existing terminal PS in the cell CL2 and the base station BS2, thereby preventing degradation of the communication quality of the wireless packet communication between the terminal PS and the base station BS2 (such as interruption of voice in a voice call from the terminal PS in the cell CL2 via the wireless packet communication and interruption of an image of image data streamed by the terminal PS in the cell CL2 via the wireless packet communication). The handover threshold calculator 223 changes the handover threshold of the terminal PS2 in the same manner as that of the terminal PS1.

The handover threshold calculator 223 can also change the handover threshold on the basis of the application type included in the terminal information of the existing terminal PS in the cell CL1 in which the terminal PS1 as a target of the threshold changing is located and the application type included in the terminal information of the existing terminal PS in the cell CL2 adjacent to the cell CL1. When a larger number of the terminals PS performing the wireless packet communication involved in the wireless communication application highly requiring real-time performance are located in the cell CL2 than in the cell CL1, for example, the handover threshold calculator 223 lowers the handover threshold of the terminal PS1 to make it difficult for the terminal PS1 to perform handover to the base station BS2, thereby preventing the decrease in the bit rate of the wireless packet communication of the existing terminal PS in the cell CL2.

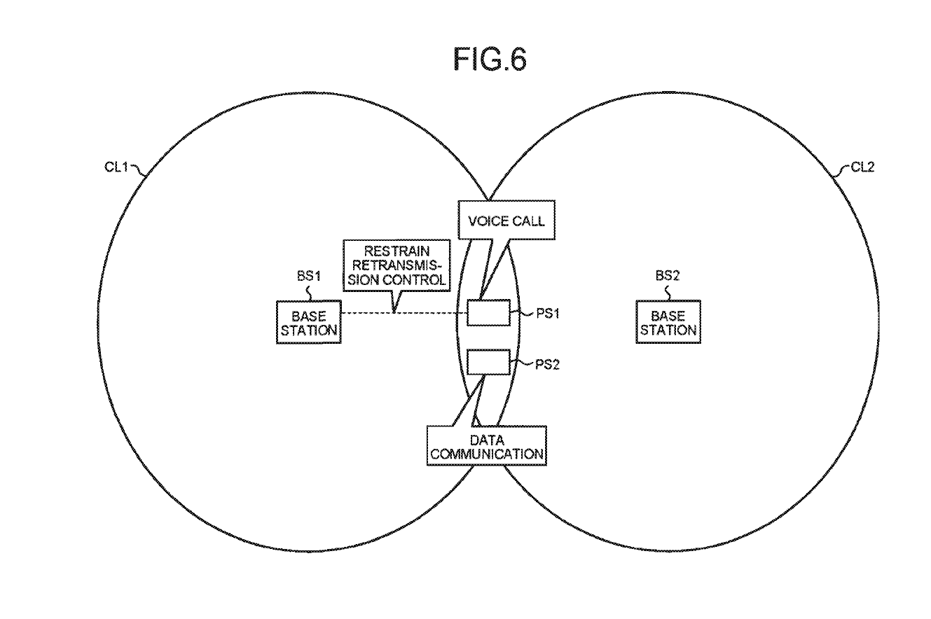

Next, referring to FIG. 6, a process of restraining retransmission of a received signal via the wireless packet communication in the communication control system according to the present embodiment will be described. FIG. 6 is a diagram illustrating the process of restraining retransmission of the received signal via the wireless packet communication in the communication control system according to the first embodiment.

When receiving the terminal information of the terminal PS1 from the terminal information aggregator 221, the handover threshold calculator 223 specifies the application type of a wireless application involved in the wireless packet communication between the terminal PS1 and the base station BS1 on the basis of the application type included in the terminal information, as described with reference to FIG. 4. Then, as illustrated in FIG. 6, the handover threshold calculator 223 lowers the preset handover threshold of the terminal PS1 and restrains retransmission of the received signal to the terminal PS1 via the wireless packet communication when the specified application type indicates the wireless communication application involved in the wireless packet communication having a high requirement for real-time performance (when the application type indicates a high requirement for real-time communication) and when the delay time included in the terminal information is shorter than a certain allowable delay time. Herein, the restraint of retransmission refers to decreasing the number of retransmissions of the received signal or elongating an interval at which the received signal is retransmitted.

That is, when the terminal PS1 is in wireless packet communication by the wireless communication application involved in the wireless packet communication such as voice call or image data streaming having a high requirement for real-time communication, the handover threshold calculator 223 can satisfy the requirement for real-time performance even at an increased error rate of the wireless packet communication of the terminal PS1 as long as the interruption of voice and image caused by frequent handovers is prevented. Therefore, the load on a network from the retransmission of the received signal is reduced by the restraint of the retransmission.

Thus, the controller S of the communication control system in the first embodiment can change the handover threshold on the basis of at least either the error rate or delay time of the wireless packet communication between the terminal PS and the base station BS and the application type of the wireless communication application involved in the wireless packet communication between the terminal PS and the base station BS. Thereby, the controller S can prevent handovers from frequently occurring to maintain the real-time performance of the wireless packet communication when the wireless communication application highly requiring real-time performance is involved in the wireless packet communication. When the wireless communication application not highly requiring real-time performance is involved in the wireless packet communication, the controller S can mitigate packet loss to improve the accuracy of data transmitted/received via the wireless packet communication.

The handover threshold calculator 223 can also change the handover threshold on the basis of at least either the error rate or delay time of the wireless packet communication between the terminal PS and the base station BS, the application type of the wireless communication application involved in the wireless packet communication between the terminal PS and the base station BS, and an allowable packet loss rate corresponding to the wireless communication application indicated by the application type.

The handover threshold calculator 223 for example increases the rate at which the handover threshold is lowered from the handover threshold before it changes, when the application type indicates a low requirement for real-time communication, the error rate of the wireless packet communication between the terminal PS and the base station BS is lower than a certain allowable error rate, and the allowable packet loss rate corresponding to the wireless communication application is high. Meanwhile, the handover threshold calculator 223 decreases the rate at which the handover threshold is lowered from the handover threshold before it changes, when the application type indicates a low requirement for real-time communication, the error rate of the wireless packet communication between the terminal PS and the base station BS is lower than the certain allowable error rate, and the allowable packet loss rate corresponding to the wireless communication application is low.

Moreover, the handover threshold calculator 223 increases the rate at which the handover threshold is lowered from the handover threshold before it changes, when the application type indicates a high requirement for real-time communication, the delay time of the wireless packet communication between the terminal PS and the base station BS is shorter than a certain allowable delay time, and the allowable packet loss rate corresponding to the wireless communication application is high. On the other hand, the handover threshold calculator 223 decreases the rate at which the handover threshold is lowered from the handover threshold before it changes, when the application type indicates a requirement for real-time communication, the delay time of the wireless packet communication between the terminal PS and the base station BS is shorter than the certain allowable delay time, and the allowable packet loss rate corresponding to the wireless communication application is low.

The handover threshold calculator 223 can also change the handover threshold on the basis of at least either the error rate or delay time of the wireless packet communication between the terminal PS and the base station BS, the application type of the wireless communication application involved in the wireless packet communication between the terminal PS and the base station BS, and a codec of the received signal received by the terminal PS via the wireless packet communication.

Furthermore, as described above, the handover threshold calculator 223 specifies the application type of the wireless communication application involved in the wireless packet communication between the terminal PS and the base station BS according to the terminal information notified from the terminal PS to the base station BS. However, the handover threshold calculator 223 may also specify the application type of the wireless communication application involved in the wireless packet communication between the terminal PS and the base station BS using a QCI (QoS Class Identifier), for example.

Moreover, the handover threshold calculator 223 groups the application types of the wireless communication applications on the basis of a guaranteed bit rate for the wireless packet communication involved in the wireless communication application indicated by the application type. The handover threshold calculator 223 can then change the handover threshold according to one of the groups to which the application type specified using the terminal information or QCI belongs.

The handover threshold calculator 223 for example lowers the handover threshold to make the handover of the terminal PS difficult, thereby preventing the terminal PS from performing handover to the base station BS conducting a wireless packet communication at a high error rate when the application type specified using the terminal information or QCI belongs to a group with a low guaranteed bit rate and at the same time the error rate of the wireless packet communication between the terminal PS and the base station BS is lower than the certain allowable error rate. On the other hand, the handover threshold calculator 223 lowers the handover threshold to make the handover of the terminal PS difficult, thereby preventing the handover of the terminal PS to the base station BS conducting the wireless packet communication with a longer delay time, when the application type specified according to the terminal information or QCI belongs to a group with a high guaranteed bit rate and at the same time the delay time of the wireless packet communication between the terminal PS and the base station BS is shorter than the certain allowable delay time.

Moreover, the handover threshold calculator 223 groups the application types of the wireless communication application according to the certain allowable delay time corresponding to the wireless communication applications indicated by the application type. The handover threshold calculator 223 can then change the handover threshold according to one of the groups to which the application type specified using the terminal information or QCI belongs.

The handover threshold calculator 223 for example lowers the handover threshold to make it difficult for the terminal PS to perform handover, thereby preventing the handover of the terminal PS to the base station BS conducting the wireless packet communication at a low error rate when the application type specified according to the terminal information or QCI belongs to a group with a long certain allowable delay time and at the same time the error rate of the wireless packet communication between the terminal PS and the base station BS is lower than the certain allowable error rate. Meanwhile, the handover threshold calculator 223 lowers the handover threshold to make it difficult for the terminal PS to perform handover, thereby preventing the handover of the terminal PS to the base station BS conducting the wireless packet communication with a longer delay time when the application type specified using the terminal information or QCI belongs to a group with a short certain allowable delay time and at the same time the delay time of the wireless packet communication between the terminal PS and the base station BS is shorter than the certain allowable delay time.

Moreover, the handover threshold calculator 223 groups the application types of the wireless communication applications on the basis of a certain allowable packet loss rate corresponding to the wireless communication application indicated by the application type. The handover threshold calculator 223 can then change the handover threshold according to one of the groups to which the application type specified using the terminal information or QCI belongs.

The handover threshold calculator 223 for example lowers the handover threshold to make it difficult for the terminal PS to perform handover when the application type specified using the terminal information or QCI belongs to a group with a low certain allowable packet loss rate and at the same time the error rate of the wireless packet communication between the terminal PS and the base station BS is lower than the certain allowable error rate, thereby preventing the handover of the terminal PS to the base station BS conducting the wireless packet communication at a low error rate. Meanwhile, the handover threshold calculator 223 lowers the handover threshold to make it difficult for the terminal PS to perform handover, thereby preventing the handover of the terminal PS to the base station BS conducting the wireless packet communication with a longer delay time, when the application type specified using the terminal information or QCI belongs to a group with a high certain allowable packet loss rate and at the same time the delay time of the wireless packet communication between the terminal PS and the base station BS is shorter than the certain allowable delay time.

### Second Embodiment

The present embodiment illustrates an example where any base station (hereinafter referred to as a representative base station) among base stations of a communication control system can change a handover threshold of each terminal. Description of a part of the second embodiment similar to that of the first embodiment will be omitted in the following.

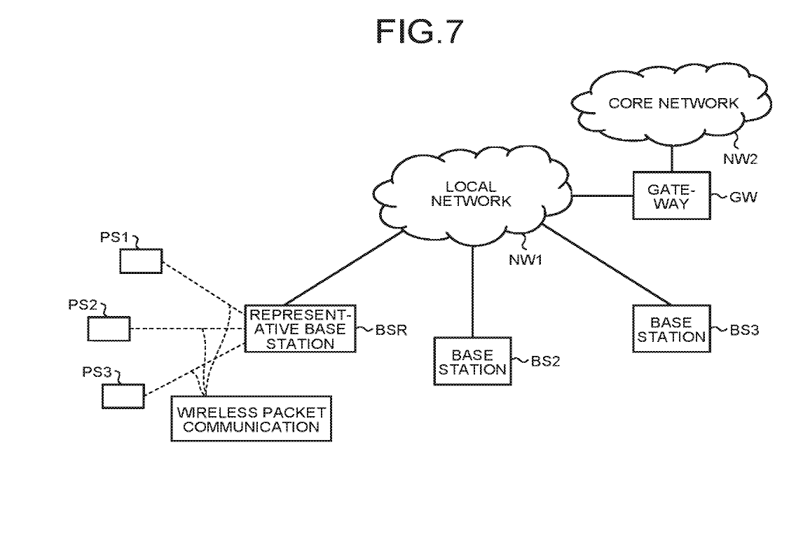

FIG. 7 is a block diagram illustrating a configuration of a communication control system according to a second embodiment. As illustrated in FIG. 7, the communication control system of the present embodiment is different from the communication control system of the first embodiment (refer to FIG. 1) in including a representative base station BSR that controls handover to switch a base station BS for a wireless packet communication with a terminal PS. That is, in the present embodiment, any of the base stations BS of the communication control system functions as the representative base station BSR having a function of the controller S according to the first embodiment. Specifically, the representative base station BSR is defined to be a base station BS including a CPU with a high throughput or a large capacity memory among the base stations BS of the communication control system. In the following the base station will be simply referred to as the base station BS unless the base station BS and the representative base station BSR need to be distinguished from each other.

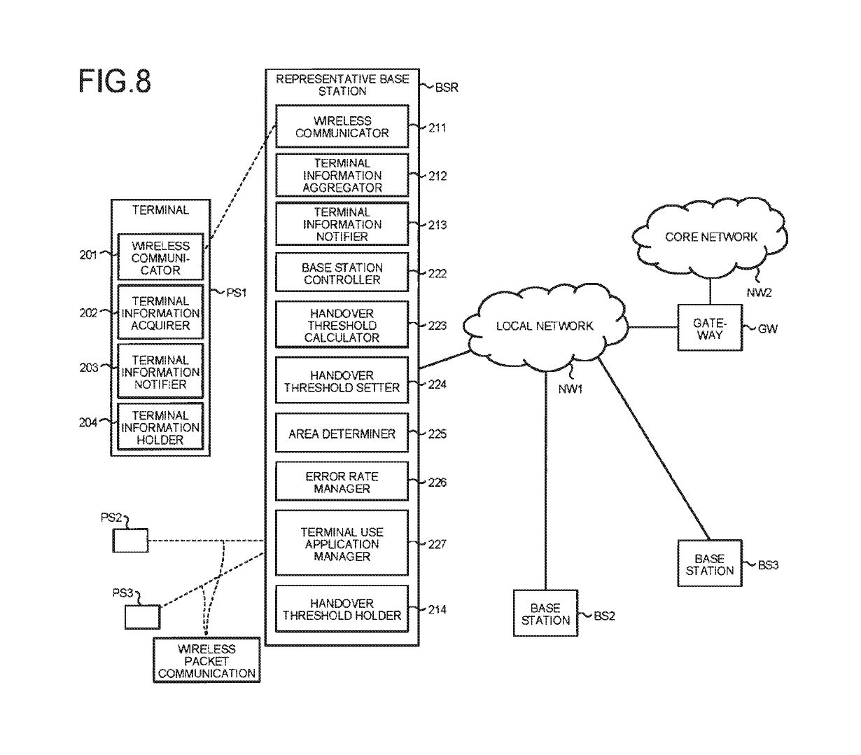

FIG. 8 is a diagram illustrating a schematic configuration of respective elements of the communication control system according to the second embodiment. The representative base station BSR of the present embodiment includes a base station controller 222, a handover threshold calculator 223, a handover threshold setter 224, an area determiner 225, an error rate manager 226 and a terminal-use application manager 227 of the controller S of the first embodiment in addition to a wireless communicator 211, a terminal information aggregator 212, a terminal information notifier 213 and a handover threshold holder 214.

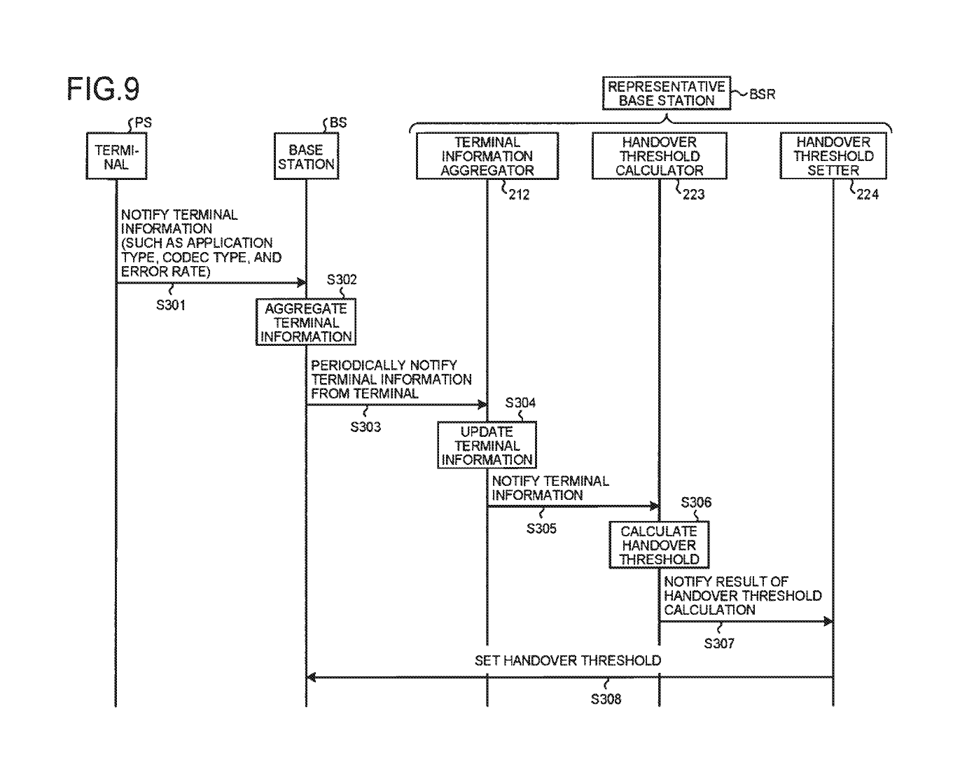

Next, referring to FIG. 9, a handover threshold changing process in the communication control system according to the present embodiment will be described. FIG. 9 is a sequence diagram illustrating a flow of the handover threshold changing process in the communication control system according to the second embodiment.

In the present embodiment, upon start of a wireless packet communication between the terminal PS and the base station BS, the handover threshold setter 224 of the representative base station BSR specifies a wireless communication application on the basis of the application type included in terminal information received first from the base station BS after the start of the wireless packet communication. The handover threshold setter 224 then sets a certain handover threshold corresponding to the specified wireless communication application to the base station BS.

Upon the start of the wireless packet communication between the terminal PS and the base station BS, the terminal information acquirer 202 of the terminal PS periodically acquires the terminal information and updates terminal information of each terminal PS stored in the terminal information holder 204 to the acquired terminal information. Moreover, the terminal information notifier 203 notifies the terminal information to the base station BS performing the wireless packet communication (step S301).

The terminal information aggregator 212 of the base station BS receives the terminal information from the terminal PS in the wireless packet communication and stores the received terminal information (step S302). Then, the terminal information notifier 213 periodically notifies the representative base station BSR of the received terminal information (step S303).

The terminal information aggregator 212 of the representative base station BSR receives the terminal information from the base station BS and updates the terminal information stored for each terminal PS in the terminal-use application manager 227 to the received terminal information (step S304). Moreover, the terminal information aggregator 212 notifies the handover threshold calculator 223 of the received terminal information (step S305).

The handover threshold calculator 223 calculates a handover threshold on the basis of at least either an error rate or a delay time of the wireless packet communication and the application type included in the terminal information from the terminal information aggregator 212 (step 3306), and notifies the handover threshold setter 224 of a result of the calculation (step 3307). Then, the handover threshold setter 224 notifies the base station BS of the handover threshold received from the handover threshold calculator 223 to change the handover threshold stored in the handover threshold holder 214 of the base station BS (step S308). A specific handover threshold changing by the handover threshold setter 224 is similar to that by the handover threshold calculator 223 of the controller S in the first embodiment and thus a description thereof will be omitted.

Therefore, as described above, the communication control system of the second embodiment can obtain the same effects as the first embodiment by setting any of the base stations BS of the communication control system as the representative base station BSR to change the handover threshold of each terminal PS.

According to the first and second embodiments as described above, the real-time performance of the wireless packet communication can be maintained when the wireless communication application highly requiring real-time communication is involved in the wireless packet communication. Meanwhile, the accuracy of data transmitted/received via the wireless packet communication can be improved when the wireless communication application not highly requiring real-time communication is involved in the wireless packet communication.

Each of the terminal PS, the base station BS (including the representative base station BSR) and the controller S of the present embodiment includes a controller such as a CPU (Central Processing Unit), a storage such as a ROM (Read Only Memory) or a RAM (Random Access Memory), and an external storage such as an HDD (Hard Disk Drive) or a CD drive.

Programs executed by the terminal PS, the base station BS and the controller S of the present embodiment are stored in an installable or executable file format on a computer-readable recording medium such as a CD-ROM, a flexible disk (FD), a CD-R, or a DVD (Digital Versatile Disk).

Moreover, the programs executed by the terminal PS, the base station BS and the controller S of the present embodiment may be stored on a computer connected to a network such as the Internet and downloaded via the network. The program executed by the terminal PS, the base station BS and the controller S of the present embodiment may also be provided or distributed via a network such as the Internet.

The program executed by the terminal PS of the present embodiment has a modular structure including each of the aforementioned elements (the wireless communicator 201, the terminal information acquirer 202 and the terminal information notifier 203). As actual hardware, a CPU (processor) reads the program from the storage medium and executes the program to load the aforementioned elements on a main storage to create the wireless communicator 201, the terminal information acquirer 202 and the terminal information notifier 203 on the main storage.

Moreover, the program executed by the base station BS of the present embodiment has a modular structure including the aforementioned elements (the wireless communicator 211, the terminal information aggregator 212 and the terminal information notifier 213). As actual hardware, a CPU (processor) reads the program from the storage medium and executes the program to load each of the aforementioned elements on a main storage to create the wireless communicator 211, the terminal information aggregator 212 and the terminal information notifier 213 on the main storage.

Furthermore, the program executed by the controller S (or the representative base station BSR) of the present embodiment has a modular structure including the aforementioned elements (the terminal information aggregators 212 and 221, the base station controller 222, the handover threshold calculator 223, the handover threshold setter 224 and the area determiner 225). As actual hardware, a CPU (processor) reads the program from the storage medium and executes the program to load the aforementioned elements on a main storage to create the terminal information aggregators 212 and 221, the base station controller 222, the handover threshold calculator 223, the handover threshold setter 224 and the area determiner 225 on the main storage.

While several embodiments of the present invention have been described, these embodiments have been illustrated by way of example and are not intended to limit the scope of the invention. These novel embodiments can be implemented in various other modes and be subjected to various omissions, substitutions and modifications without departing from the gist of the invention. These embodiments and variations thereof are included in the scope and gist of the invention as well as in the inventions described in claims and its equivalents.

1: A communication control device comprising:
a controller that performs handover to switch a base station for a wireless packet communication with an information processing terminal when a received power of a received signal falls below a preset handover threshold, the received signal being received by the information processing terminal from the base station via the wireless packet communication; and
a change unit that changes the threshold on the basis of a type of an application and at least either an error rate or a delay time of the wireless packet communication between the information processing terminal and the base station, the application being involved in the wireless packet communication between the information processing terminal and the base station.

2: The communication control device according to claim 1, wherein the change unit lowers the threshold when the type of the application indicates a high requirement for real-time communication and when the delay time of the wireless packet communication involved in the application is shorter than a certain allowable delay time.

3: The communication control device according to claim 2, wherein the change unit restrains retransmission of the received signal.

4: The communication control device according to claim 1, wherein the change unit lowers the threshold when the type of the application indicates a low requirement for real-time communication and when the error rate of the wireless packet communication involved in the application is lower than a certain allowable error rate.

5: The communication control device according to claim 1, wherein the change unit changes the threshold on the basis of an allowable packet loss rate corresponding to the application indicated by the type of the application.

6: The communication control device according to claim 1, wherein the change unit groups types of applications on the basis of a bit rate guaranteed for the wireless packet communication involved in the application of the type, and changes the threshold on the basis of a group to which the type of the application belongs.

7: The communication control device according to claim 1, wherein the change unit groups types of applications on the basis of a certain allowable delay time corresponding to the application of the type, and changes the threshold on the basis of a group to which the type of the application belongs.

8: The communication control device according to claim 1, wherein the change unit groups types of applications on the basis of a certain allowable packet loss rate corresponding to the application of the type, and changes the threshold on the basis of a group to which the type of the application belongs.

9: The communication control device according to claim 1, wherein the change unit changes the threshold on the basis of priority preset to the information processing terminal located within a cell of the base station in wireless packet communication with the information processing terminal.

10: The communication control device according to claim 1, wherein the change unit changes the threshold on the basis of a codec of the received signal.

11: The communication control device according to claim 1, wherein the change unit specifies the type of the application by using on the basis of a QoS Class Identifier.

12: A communication control method executed by a communication control device, the method comprising:
performing handover to switch a base station for a wireless packet communication with an information processing terminal when a received power of a received signal falls below a preset handover threshold, the received signal being received by the information processing terminal from the base station via the wireless packet communication; and
changing the threshold on the basis of a type of an application and at least either an error rate or a delay time of the wireless packet communication between the information processing terminal and the base station, the application being involved in the wireless packet communication between the information processing terminal and the base station.

13: A computer program product including programmed instructions embodied in and stored on a non-transitory computer readable medium, wherein the instructions, when executed by a computer, cause the computer to perform:
performing handover to switch a base station for a wireless packet communication with an information processing terminal when a received power of a received signal falls below a preset handover threshold, the received signal being received by the information processing terminal from the base station via the wireless packet communication; and
changing the threshold on the basis of a type of an application and at least either an error rate or a delay time of the wireless packet communication between the information processing terminal and the base station, the application being involved in the wireless packet communication between the information processing terminal and the base station.
